(19) United States
(12) Patent Application Publication
(10) Pub. No.: US 2009/0053479 A1
(43) Pub. Date: Feb. 26, 2009

(54) Disazo Dyes for Ink-Jet Printing

(76) Inventor: Gavin Wright, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 11/886,971

(22) PCT Filed: Mar. 27, 2006
(86) PCT No.: PCT/GB2006/001128

§ 371 Date: Sep. 24, 2007

(30) Foreign Application Priority Data
Mar. 31, 2005 (GB) 0506496.9

(51) Int. Cl. B32B 3/10; C09B 31/02; B05D 5/00; C09D 11/02

(52) U.S. Cl. 428/195.1; 534/797; 427/256; 106/31.48

(57) ABSTRACT

A compound of Formula (1) or salt thereof:

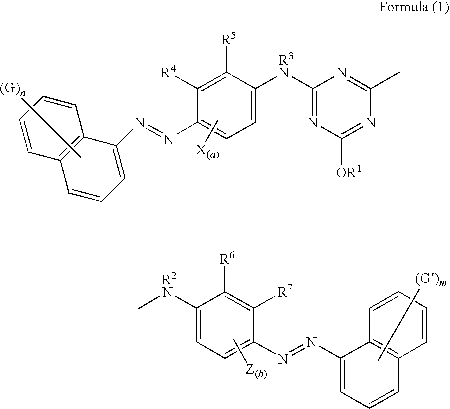

Also, claimed are inks, a process for printing an image on a substrate using the inks and substrates printed with said inks. The compounds of Formula (1) provide colorants especially suitable for ink jet printing having good light and ozone fastness.

This invention relates to compounds suitable for use as dyes, to inks and to their use in ink jet printing (“IJP”). IJP is a non-impact printing technique in which droplets of ink are ejected through a fine nozzle onto a substrate without bringing the nozzle into contact with the substrate.

There are many demanding performance requirements for dyes and inks used in IJP. For example they desirably provide sharp, non-feathered images having good water-fastness, light-fastness and optical density. The inks are often required to dry quickly when applied to a substrate to prevent smudging, but they should not form a crust over the tip of an ink jet nozzle because this will stop the printer from working. The inks should also be stable to storage over time without decomposing or forming a precipitate that could block the fine nozzle.

It has now surprisingly been found that certain compounds provide valuable colorants for ink jet printing inks.

According to a first aspect of the present invention there is provided a compound of Formula (1) and salts thereof:

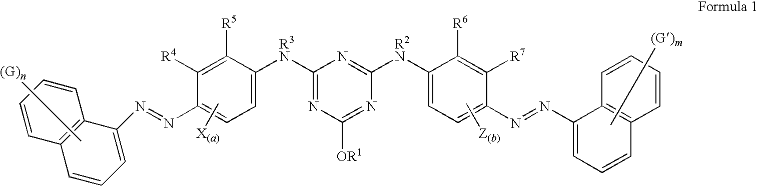

wherein:
R⁴, R⁵, R⁶ and R⁷ are each independently H or an optionally substituted substituent or R⁴ and R⁵ and/or R⁶ and R⁷ together with the carbon atoms to which they are attached form an optionally substituted aryl or heterocyclic ring;
X and Z are each independently H or an optionally substituted substituent;
R¹ is H or C₁₋₄-alkyl;
R² and R³ are each independently H, C₁₋₄-alkyl, —CONR⁸R⁹, —SO₂NR⁸R⁹ or aryl groups; wherein R⁸ and R⁹ are each independently H, optionally substituted C₁₋₄-alkyl, an optionally substituted aryl or heterocyclic ring, or R⁸ and R⁹ together with the nitrogen atom to which they are attached form an optionally substituted 5 or 6 membered ring;
G and G′ are each independently a sulfonic acid group, carboxylic acid group or a phosphonic acid group;
n and m are each independently 0, 1, 2, 3, 4 or 5; and
a and b are each independently 0, 1 or 2.

Preferably both n and m are not 0. This improves the solubility of the compounds of formula (1) in aqueous media.

Preferably X and Z are each independently H, or optionally substituted alkyl, optionally substituted alkoxy, optionally substituted aryl, optionally substituted heterocyclic, —NR⁸R⁹, —NHCOR⁸, —NHCONR⁸R⁹, —C(O)R⁸, —C(O)OR⁸, —C(O)NR⁸R⁹, —PO₃H₂, —SR⁸, —SO₂R⁸, —SO₂NR⁸R⁹, —SOR⁸, —SO₃H, —CF₃, —CN, —NO₂, hydroxy or halogen, wherein R⁵ and R⁹ are each independently H, optionally substituted C₁₋₈-alkyl, optionally substituted aryl for example phenyl or optionally substituted heterocyclic, or R⁸ and R⁹ together with the nitrogen atom to which they are attached form an optionally substituted 5 or 6 membered ring (for example piperidine, pyrrolidone, pyridine, piperizine or morpholine).

Preferably R⁴, R⁵, R⁶ and R⁷ are each independently H or are as described above for X and Z, or R⁴ and R⁵ and/or R⁶ and R⁷ together with the carbon atoms to which they are attached form an optionally substituted 5 or 6 membered aryl or heterocyclic ring (for example phenyl, pyridine, pyrrole, imidazole, thiazole, pyrazine, piperidine or pyrrolidone).

When R⁴, R⁵, R⁶, R⁷, X or Z is an optionally substituted alkyl it is preferably optionally substituted C₁₋₈-alkyl, more preferably C₁₋₄-alkyl, for example methyl, ethyl, propyl, isopropyl, butyl, sec-butyl, optionally substituted by for example hydroxy, halogen, carboxy or sulfo groups. Examples include but are not limited to trifluoromethyl, hydroxyethyl, sulfopropyl and carboxyethyl.

When R⁴, R⁵, R⁶, R⁷, X or Z is an optionally substituted alkoxy it is preferably optionally substituted C₁₋₈-alkoxy more preferably C₁₋₄-alkoxy for example, methoxy, ethoxy, propoxy, isopropoxy, butoxy, optionally substituted by for example hydroxy, halogen or carboxy groups. Examples include but are not limited to carboxypropyloxy, carboxyethoxy, hydroxyethoxy or chloroethoxy.

When R⁴, R⁵, R⁶, R⁷, X or Z is an optionally substituted aryl group it is preferably optionally substituted phenyl. Optional substituents on the aryl ring include for example C₁₋₈-alkyl, C₁₋₈-alkoxy, —NR⁸R⁹, —NHCOR⁸, —NHCONR⁸R⁹, —C(O)R⁸, —C(O)OR⁸, —C(O)NR⁸R⁹, —PO₃H₂, —SR⁸, —SO₂R⁸, —SO₂NR⁸R⁹, —SOR⁸, —SO₃H, —CF₃,—CN, —NO₂, hydroxy or halogen, wherein R⁸ and R⁹ are as described previously above. Examples include but are not limited to carboxyphenyl, sulfophenyl, nitrophenyl and chlorophenyl.

When R⁴, R⁵, R⁶, R⁷, X or Z is an optionally substituted heterocyclic group it is preferably either an optionally substituted aliphatic heterocyclic group or an optionally substituted aromatic heterocyclic group, for example optionally substituted thiophene, pyrazole, triazole, thiadiazole, thiazole, imidazole, pyridine, pyrrolidone, piperizine, morpholine or pyrimidine. Optional substituents on the heterocyclic ring include for example C₁₋₈-alkyl, —NR⁸R⁹, —NHCOR⁸, —NHCONR⁸R⁹, —C(O)OR⁸, —C(O)NR⁸R⁹, —SR⁸, —SO₂R⁸, —SO₂NR⁸R⁹, —SOR⁸, —SO₃H, —CF₃, —CN, —NO₂, hydroxy or halogen, wherein R⁸ and R⁹ are as previously described above. Examples include but are not limited to carboxytriazole, chloropyridyl and cyanothiophene.

It will be appreciated that in the compounds of Formula (1), R⁴, R⁵, R⁶, R⁷, X and Z may be each independently the same or different. It is more preferred however that in the compounds of Formula (1) R⁴, R⁵, R⁶, R⁷, X and Z are each independently H, optionally substituted C₁₋₄-alkyl, preferably methyl or ethyl, optionally substituted C₁₋₄-alkoxy, preferably methoxy or ethoxy, —SO₂NR⁸R⁹ or —NHCONR⁸R⁹ wherein R⁸ and R⁹ are as described above, but most preferably R⁸ is H and R⁹ is H, optionally substituted C₁₋₄-alkyl (preferably methyl or ethyl) or aryl (preferably phenyl).

Most preferably however, R⁴, R⁵, R⁶, R⁷, X and Z are each independently H, C₁₋₂-alkyl, C₁₋₂-alkoxy or NHCONR⁸R⁹ wherein R⁸ and R⁹ are both H.

Preferably, one or more of the groups represented by R⁴, R⁵, R⁶ and R⁷ is H.

R² and R³ are each most preferably H.

R¹ is preferably H.

Preferably R¹, R² and R³ are all H.

Preferably, the compound of Formula (1) has from 2 to 6, more preferably from 4 to 6 sulfonic acid groups.

It is most preferred that G and G′ is a sulfonic acid group.

It is preferred that n and m are each independently 1, 2 or 3 most preferably 2 or 3.

It is preferred that a and b are each independently 0 or 1.

It is preferred that one or both of R⁴ and R⁵, and/or R⁵ and R⁷ is H.

In a preferred embodiment of the present invention the compound of Formula (1) is preferably a compound of Formula (2) or a salt thereof:

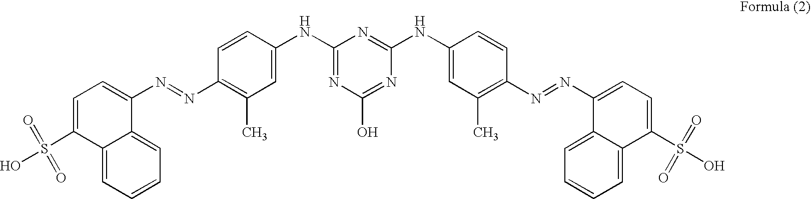

It is especially preferred that the compounds of Formula (1) are yellow, orange or brown in colour. More preferably, dilute inks comprising the compounds of Formula (1) are yellow in colour. The compounds of the present invention exhibit particularly good ozone fastness, light fastness and optical density, making them especially suitable as colorants for photorealistic and other ink jet printing applications providing bright yellow ink jet prints.

The compounds of Formula (1) also have good solubility in an ink jet ink and good operability in ink jet printers. Inks comprising a compound of Formula (1) exhibit a low tendency to crust over or block nozzles of an ink jet printer.

Compounds of Formula (1) are preferably free from fibre reactive groups because compounds containing such groups tend to have reduced operability. The term fibre reactive group is well known in the art and is described for example in EP 0356014 A1. Fibre reactive groups are capable, under suitable conditions, of reacting with the hydroxy groups present in cellulosic fibres or with the amino groups present in natural fibres to form a covalent linkage between the fibre and the dye. As examples of fibre reactive groups which are most preferably absent from the compounds of Formula (1) there may be specifically mentioned aliphatic sulfonyl groups which also contain a sulfate ester group in the beta-position to the sulfur atom, for example, beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, for example, the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of specific cellulose reactive groups which are preferably absent include: tetrafluorocyclobutyl carbonyl, trifluoro-cyclobutenyl carbonyl, tetrafluorocyclobutylethenyl carbonyl, trifluoro-cyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring.

The compounds of Formula (1) according to the present invention are suitable for use as dyes for ink jet printing and may be prepared by, for example, the hydrolysis of the monochloro triazinyl dye of Formula (3). Preferably, the hydrolysis is performed in alkali solution utilising sodium or lithium hydroxide as the base at 60-80° C. for 4-10 hours.

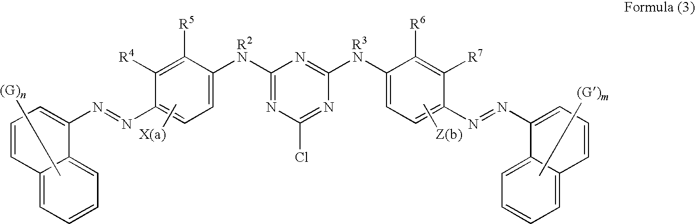

The compounds of Formula (3) may be prepared, for example, by the condensation of 1 mole of Formula (4a) and 1 mole of Formula (4b) with 1 mole of cyanuric chloride, or to achieve a symmetrical molecule 2 moles of the monoazo compound of either Formula (4a) or (4b) with 1 mole of cyanuric chloride. The condensation is preferably performed in aqueous solution at 0 to 40° C. and pH 5 to 7.

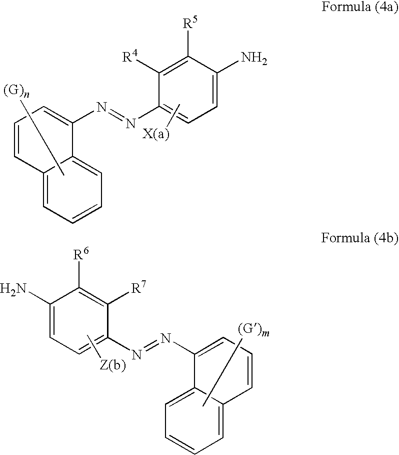

The compounds of Formulae (4a) and (4b) may be prepared by, for example, diazotising a compound of the Formula (5a) or (5b) to give a diazonium salt and coupling the resultant diazonium salt with a compound of Formula (6a) or Formula (6b) respectively:

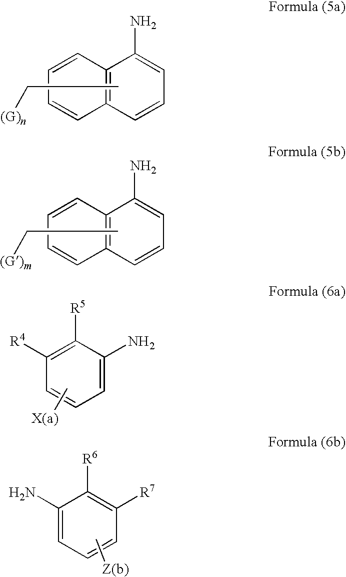

wherein:

G, G′, X, Z, R⁴, R⁵, R⁶, R⁷, n, m, a and b are as hereinbefore defined in relation to Formula (1).

The diazotisation is preferably performed at a temperature below 20° C., more preferably at a temperature from 0° C. to 5° C. Preferably, the diazotisation is performed in water, preferably at a pH below 7. Dilute mineral acid, e.g. HCl or H₂SO₄ or an organic acid (for example acetic acid, propionic acid) or a mixture thereof may be used to achieve the desired acidic conditions.

The compounds of Formula (1) may be in the free acid or salt form. Preferred salts are water-soluble, for example alkali metal salts, (especially lithium, sodium, potassium), ammonium, substituted ammonium and mixed salts thereof. Preferred metal salts are those with sodium and lithium.

Preferred ammonium and substituted alkyl ammonium salts have cations of the formula ⁺NV₄ wherein each V independently is H or optionally substituted alkyl, or two groups represented by V are H or optionally substituted alkyl and the remaining two groups represented by V, together with the N atom to which they are attached, form a 5 or 6 membered ring.

Preferably, each V independently is H or C₁₋₄-alkyl, more preferably H, CH₃ or CH₂CH₃, especially H.

Preferred cyclic cations comprise a morpholinyl, pyridinyl or piperidinyl ring.

Examples of cations include ⁺NH₄, morpholinium, piperidinium, pyridinium, is (CH₃)₃N⁺H, (CH₃)₂N⁺H₂, H₂N⁺(CH₃)(CH₂CH₃), CH₃N⁺H₃, CH₃CH₂N⁺H₃, H₂N⁺(CH₂CH₃)₂, CH₃CH₂CH₂N+H₃, (CH₃)₂CHN⁺H₃, N⁺(CH₃)₄, N⁺(CH₂CH₃)₄, N-methylpyridinium, N,N-dimethyl piperidinium and N,N-dimethyl morpholinium.

It is especially preferred that the compounds of Formula (1) according to the present invention are in the form of a sodium, lithium, potassium, ammonium, substituted ammonium salt or mixtures thereof.

The compounds of Formula (1) may be converted into a salt using known techniques. For example, an alkali metal salt of a compound may be converted into a salt with ammonia or an amine by dissolving an alkali metal salt of the compound in water acidifying with a mineral acid and collecting the precipitated free acid by filtration. The isolated solid is then dissolved in water and the pH of the solution adjusted to pH 9 to 9.5 with ammonia or the amine and the alkali metal cations are then removed by dialysis. The desired salt form may also be prepared by dissolving an alkali metal salt of the compound of Formula (1) in water and passing the solution through a column of a suitably modified ion exchange resin.

Preferably, the compound of Formula (1) is a dye and more preferably a water-soluble dye.

The compounds of the present invention may exist in tautomeric forms other than those shown in this specification. These tautomers are also included within the scope of the present invention.

The compounds of Formula (1) according to the present invention may be used as the sole colorant in inks because many such colorant have the desired yellow or orange shade. However, if desired, one may prepare a colorant mixture comprising the compounds of Formula (1) or salts thereof and one or more colorants other than a compound of Formula (1) or salt there (hereinafter further colorants). Colorant mixtures are particularly useful if a slightly different shade is required for a particular end use.

According to a second aspect of the present invention there is provided a composition comprising:
a) two or more compounds of Formula (1) or salts thereof according to the first aspect of the present invention; or
b) one or more compounds of Formula (1) or salts thereof according to the first aspect of the present invention and one or more colorants other than a compound of Formula (1).

Preferably, the compositions according to the second aspect of the present invention are mixed so as to provide a uniform colour.

The further colorant may be a pigment or a dye.

When further colorants are included in the ink these are preferably selected from yellow, magenta, cyan and black colorants and combinations thereof, most preferably yellow or magenta colorants and combinations thereof.

Suitable further colorants are those listed in the Colour Index International, to adjust the shade or other properties as desired. Suitable yellow colorants include but are not limited to: C.I. Acid Yellow 17, 19, 23, 25, 40, 42, 44, 49, 61, 127, 151, 199, 219; C.I. Direct Yellow 8, 11, 12, 27, 28, 29, 44, 50, 85, 86, 96, 106, 132, 142, 173 and salts thereof.

Suitable further magenta colorants include: PRO-JET™ Fast Magenta 2, PRO-JET™ Magenta BTX, 3BOA, 2BTX and 1T; C.I. Acid Red 52 and 249; C.I. Reactive Red 180, 31 and 23; and C.I. Direct Red 227.

Suitable further cyan colorants include: phthalocyanine colorants, C.I. Direct Blue 199 and C.I. Acid Blue 99.

Suitable further black colorants include: C.I. Food Black 2, C.I. Direct Black 19, C.I. Reactive Black 31, PRO-JET™ Fast Black 2, C.I. Direct Black 195; C.I. Direct Black 168; and black dyes described in patents by Lexmark (for example EP 0 539,178 A2, examples 1, 2, 3, 4 and 5), Orient Chemicals (for example EP 0 347 803 A2, pages 5 to 6, azo dyes 3, 4, 5, 6, 7, 8, 12, 13, 14, 15 and 16) and Seiko Epson Corporation.

It is preferred that the colorant other than a compound of Formula (1) for use in the composition according to the second aspect of the invention comprises a water-soluble dye or salt thereof.

The composition according to the second aspect of the present invention preferably comprises:
(a) from 1 to 99, more preferably from 3 to 70 and especially from, 5 to 50 parts in total of the compound(s) according to the first aspect of the invention; and
(b) from 99 to 1, more preferably from 30 to 97 parts and especially 95 to 50 parts in total of a water-soluble dye(s) other than a compound of Formula (1) or salt thereof;
   wherein the parts are by weight and the sum of the parts (a)+(b)=100.

The composition may contain a single compound of Formula (1) or a mixture thereof. Similarly, the composition may contain in (b) a single water-soluble dye or a mixture of two or more water-soluble dyes other than a compound of Formula (1) or salt thereof.

The compounds and compositions according to the first and second aspects of the present invention may be, and preferably are, purified to remove undesirable impurities before they are incorporated into inks for ink jet printing. Conventional techniques may be employed for purification, for example ultrafiltration, reverse osmosis and/or dialysis.

According to a third aspect of the present invention there is provided an ink comprising:
(a) a compound of Formula (1) or salts thereof according to the first aspect of the present invention, or a composition according to the second aspect of the invention; and
(b) a liquid medium.
   The liquid medium preferably comprises:
(i) water;
(ii) a mixture of water and an organic solvent; or
(iii) an organic solvent free from water.
   A preferred ink according to the third aspect of the present invention comprises:
(a) from 0.01 to 30 parts of a compound of Formula (1) or salt thereof as hereinbefore described; and
(b) from 70 to 99.99 parts of a liquid medium;
wherein the liquid medium comprises an organic solvent, the parts are by weight and the number of parts of (a) and (b)=100.

The number of parts by weight of component (a) is preferably from 0.01 to 30, more preferably 0.1 to 20, especially from 0.5 to 15, and more especially from 1 to 5 parts. The number of parts by weight of component (b) is preferably from 99.99 to 70, more preferably from 99.9 to 80, especially from 99.5 to 85, and more especially from 99 to 95 parts. The number of parts (a)+(b) is 100 and all parts mentioned here are by weight.

Preferably component (a) is completely dissolved in component (b). Preferably component (a) has a solubility in component (b) at 20° C. of at least 10% by weight. This allows the preparation of liquid dye concentrates which may be used to prepare more dilute inks and reduces the chance of the compound(s) of component (a) of the ink precipitating if evaporation of the liquid medium occurs during storage.

When the liquid medium comprises a mixture of water and an organic solvent, the weight ratio of water to organic solvent is preferably from 99:1 to 1:99, more preferably from 99:1 to 50:50 and especially from 95:5 to 70:30.

It is preferred that the organic solvent is a water-miscible organic solvent or a mixture of such solvents. Preferred water-miscible organic solvents include: C₁₋₆-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide and sulfolane. Preferably, the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

An example of a suitable liquid medium comprises:

(a) from 75 to 95 parts water; and
(b) from 25 to 5 parts in total of one or more organic solvents selected from diethylene glycol, 2-pyrrolidone, thiodiglycol, N-methylpyrrolidone, cyclohexanol, caprolactone, caprolactam and pentane-1,5-diol;
wherein the parts are by weight and the sum of the parts (a) and (b)=100.

Another example of a suitable liquid medium comprises:
(a) from 60 to 80 parts water;
(b) from 2 to 20 parts diethylene glycol; and
(c) from 0.5 to 20 parts in total of one or more solvents selected from 2-pyrrolidone, N-methylpyrrolidone, cyclohexanol, caprolactone, caprolactam, pentane-1,5-diol and thiodiglycol;
   wherein the parts are by weight and the sum of the parts (a), (b) and (c)=100.

Examples of further suitable liquid media comprising a mixture of water and one or more organic solvents are described in U.S. Pat. No. 4,963,189, U.S. Pat. No. 4,703,113, U.S. Pat. No. 4,626,284 and EP 4,251,50A incorporated herein by reference.

When the liquid medium comprises an organic solvent free from water, (that is, less than 1% water by weight) the solvent preferably has a boiling point of from 300 to 200° C., more preferably of from 400 to 150° C., especially from 50 to 125° C. The organic solvent may be water-immiscible, water-miscible or a mixture of such solvents. Preferred water-miscible organic solvents are any of the hereinbefore described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent a polar solvent is preferably included because this enhances solubility of the dye in the liquid medium. Examples of polar solvents include C₁₋₄-alcohols. In view of the foregoing preferences it is especially preferred that where the liquid medium is an organic solvent free from water it comprises a ketone (especially methyl ethyl ketone) and/or, an alcohol (especially a C₁₋₄-alkanol, more especially ethanol or propanol).

The organic solvent free from water may be a single organic solvent or a mixture of two or more organic solvents. It is preferred that when the liquid medium is an organic solvent free from water it is a mixture of 2 to 5 different organic solvents. This allows a liquid medium to be selected that gives good control over the drying characteristics and storage stability of the ink.

Liquid media comprising an organic solvent free from water are particularly useful where fast drying times are required and particularly when printing onto hydrophobic and non-absorbent substrates, for example plastics, metal and glass.

An especially preferred ink comprises:
(a) from 1 to 10 parts in total of a compound of Formula (1) or salt thereof or a composition according to the second aspect of the invention;
(b) from 2 to 60, more preferably 5 to 40 parts of water-miscible organic solvent; and
(c) from 30 to 97, more preferably 40 to 85 parts water;

wherein all parts are by weight and the sum of the parts (a)+(b)+(c)=100.

Compounds of Formula (1) may be used in phase change inks e.g. wax-based inks. It may be appropriate to use one or more low melting solid media with a compound of Formula (1) or a composition according to the second aspect of the present invention. Preferred low melting solid media have a melting point in the range from 60° C. to 125° C. Suitable low melting point solids include long chain fatty acids or alcohols, preferably those with C₁₈₋₂₄ chains, and sulfonamides. The compound(s) of Formula (1) may be dissolved in the low melting point solid or may be finely dispersed in it.

The ink may also contain additional components conventionally used in ink jet printing inks, for example viscosity and surface tension modifiers, corrosion inhibitors, biocides, kogation reducing additives, anti-cockle agents (to reduce paper curling) and surfactants (which may be ionic or non-ionic).

The pH of the ink is preferably from 4 to 11 more preferably from 7 to 10.

The viscosity of the composition at 25° C. is preferably less than 50 mPa·s, more preferably less that 20 mPa·s and especially less than 5 mPa·s. Preferably, the viscosity is newtonian. Preferably, the viscosity is measured at a shear rate of 10 rpm using a cone and plate rheometer at a temperature of 25° C.

The ink is preferably filtered through a filter having an average pore size of less than 10 microns, more preferably the ink is filtered through a filter having an average pore size of from 10 to 0.5 microns. This reduces the amounts of oversized particles that might otherwise tend to block the ink jet printing nozzles.

When the ink according to the third aspect of the present invention is used as an ink jet printing ink, the ink preferably has a concentration of halide ions of less than 500 parts per million, more preferably less than 100 parts per million. It is especially preferred that the ink has less than 100, more preferably less than 50 parts per million of divalent and trivalent metals, wherein parts refer to parts by weight relative to the total weight of the ink. Purifying the ink to reduce the concentration of these undesirable ions reduces nozzle blockage in ink jet printing heads, particularly in thermal ink jet printers.

The inks of the present invention preferably form the yellow ink of a standard yellow, magenta, cyan and black ink set. Typically, in such an ink set the magenta ink will contain, for example, C.I. Acid Red 52 or Pro-Jet™ Fast Magenta 2, the cyan ink will contain for example C.I. Direct Blue 86, 199 or Pro-Jet™ Fast Cyan 2 and the black ink will contain for example C.I. Direct Black 199 or Pro-Jet™ Fast Black 2. (Pro-Jet is a trademark of Fujifilm Imaging Colorants Limited).

According to a fourth aspect of the present invention there is provided a process for printing an image on a substrate comprising applying to the substrate, an ink comprising a compound of Formula (1) or salt thereof according to the first aspect of the present invention or an ink comprising a composition according to the second aspect of the present invention.

Preferably, the application to the substrate is by means of an ink jet printer.

The ink used in this process is preferably as defined in accordance with the third aspect of the present invention.

The ink jet printer preferably applies the ink composition to the substrate in the form of droplets which are ejected through a small orifice onto the substrate. Preferred ink jet printers are piezoelectric ink jet printers and thermal ink jet printers.

The substrate is preferably paper, plastic, a textile, metal or glass, more preferably a treated substrate such as a coated paper, an overhead projector slide, a textile material or coated plastic, especially coated paper.

The coated paper may be coated with a porous or swellable ink receptor layer.

According to a fifth aspect of the present invention there is provided a substrate, (preferably paper, an overhead projector slide or a textile material) printed with an ink comprising a compound of Formula (1) or salt thereof according to the first aspect of the present invention or an ink comprising a composition according to the second aspect of the present invention.

When the substrate is a textile material the ink according to the third aspect of the present invention is preferably applied thereto by:
i) applying the ink to the textile material using an ink jet printer; and
ii) heating the printed textile material at a temperature of from 50° C. to 250° C.

Preferred textile materials are natural, synthetic and semi-synthetic materials. Examples of preferred natural textile materials include wool, silk, hair and cellulosic materials, particularly cotton, jute, hemp, flax and linen. Examples of preferred synthetic and semi-synthetic materials include polyamides, polyesters, polyacrylonitriles and polyurethanes.

Preferably the textile material has been treated with an aqueous pre-treatment composition comprising a thickening agent and optionally a water-soluble base and a hydrotropic agent and dried prior to step i) above.

The pre-treatment composition preferably comprises a solution of the base and the hydrotropic agent in water containing the thickening agent. Particularly preferred pre-treatment compositions are described more fully in European Patent Application No. 534660A1.

According to a sixth aspect of the present invention there is provided an ink jet printer cartridge comprising a chamber and ink, wherein the ink is present in the chamber and the ink comprises a compound according to the first aspect of the present invention or a composition according to the second aspect of the present invention. Preferably, the ink is as defined in the third aspect of the present invention.

According to a seventh aspect of the present invention there is provided an ink jet printer containing an ink jet printer cartridge according to the sixth aspect of the present invention.

According to a eighth aspect of the present invention there is provided the use of a compound or salt thereof according to the first aspect of the present invention for preparing an ink jet printing ink comprising the compound or salt thereof and a liquid medium.

The invention is further illustrated by the following examples in which all parts and percentages are by weight unless otherwise stated.

### EXAMPLE 1

### Dye (1)

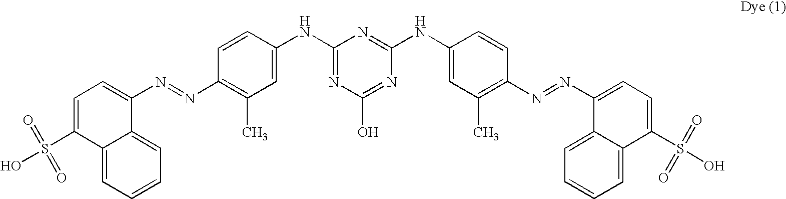

Dye (1) was prepared according to the stages (a) to (c):

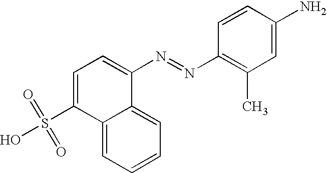

### Stage (a):

4-aminonaphthalene-1-sulfonic acid (44.6 g, 0.2 mol) was dissolved in water (600 ml) which was then adjusted to pH 7 by the addition of 2N sodium hydroxide solution followed by the addition of sodium nitrite (13.8 g, 0.2 mol) to form a solution. The solution was then added dropwise to a mixture of concentrated hydrochloric acid (100 ml) and water (100 ml) at 0-5° C. to form a reaction mixture. The reaction mixture was stirred for 2 hours at 0-5° C. m-Toluidine (21.4 g, 0.2 mol) was then added dropwise to the reaction mixture at 0-5° C., the pH was adjusted to pH 4 to 5 by the addition of sodium acetate and the reaction mixture was stirred for 4 hours at 0 to 5° C. The product was collected by filtration and dried to give a red solid.

### Stage (b):

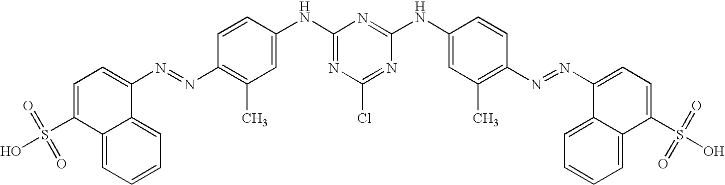

A solution of cyanuric chloride (9.2 g, 0.05 mol) in acetone (100 ml) was added to a mixture of ice/water (300 g). A first portion of the product from stage (a) (17.1 g, 0.05 mol) was dissolved in water (200 ml) which was then adjusted to pH 7 by the addition of 2N aqueous sodium carbonate to form a solution. This solution was then added to the cyanuric chloride suspension at 0 to 5° C. to form a reaction mixture. The pH of the reaction mixture was maintained at pH 5 to 6.5 (using 2N sodium carbonate solution) for 1 hour, the temperature was then allowed to warm to 20° C. A second portion of the product from stage (a) (17.1 g, 0.05 mol) was then dissolved in water (200 ml) as described above and then added to the reaction mixture at 20° C. The reaction mixture was then stirred at 30 to 40° C., pH 7 to 8 (using 2N sodium hydroxide solution) for 18 hours. The product was collected by filtration and the product used in stage (c) without drying or purification.

### Stage (c): Preparation of Dye (1):

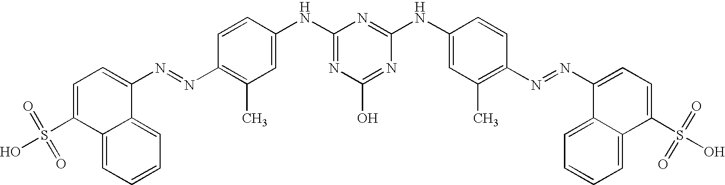

A solution of the product from stage (b) in water (1000 ml) and 48% sodium hydroxide solution (100 ml) was stirred at 60 to 70° C. for 4 hours and then allowed to cool to room temperature. The product was collected by filtration, the solid was then suspended in water (500 ml) and purified by dialysis in membrane tubing to a low conductivity (less than 50 μs). Dye (1) was obtained by evaporation at 60° C. to afford an orange solid.

### EXAMPLE 2

### Dye (2)

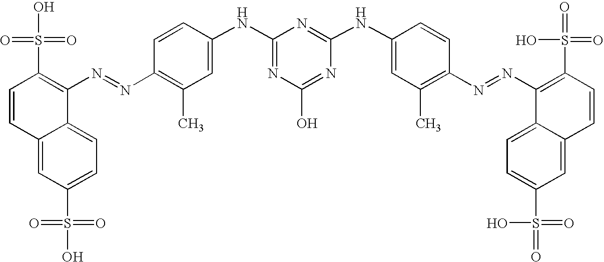

Dye (2) was prepared in exactly the same way as Dye (1) in Example 1 except that 4-aminonaphthalene-1-sulfonic acid was replaced with 1-aminonaphthalene-2,6-disulfonic acid in the same molar amounts.

### Inks

The inks described in Table I may be prepared using Dye 1. Numbers quoted in the second column onwards refer to the number of parts of the relevant ingredient and all parts are by weight. The inks may be applied to paper by thermal or piezo ink jet printing.

The following abbreviations are used in Table I:
PG=propylene glycol
DEG=diethylene glycol
NMP=N-methylpyrollidone
DMK=dimethylketone
IPA=isopropanol
MeOH=methanol
2P=2-pyrollidone
MIBK=methylisobutyl ketone
P12=propane-1,2-diol
BDL=butane-2,3-diol
CET=cetyl ammonium bromide
PHO=Na₂HPO₄
TBT=tertiary butanol
TDG=thiodiglycol

TABLE I

| | Dye | | | | | | | Na | | | | |
|---|---|---|---|---|---|---|---|---|---|---|---|---|
| Dye | Content | Water | PG | DEG | NMP | DMK | NaOH | Stearate | IPA | MEOH | 2P | MIBK |
| 1 | 2.0 | 80 | 5 | | 6 | 4 | | | | | 5 | |
| 1 | 3.0 | 90 | | 5 | 5 | | 0.2 | | | | | |
| 1 | 10.0 | 85 | 3 | | 3 | 3 | | | | 5 | 1 | |
| 1 | 2.1 | 91 | | 8 | | | | | | | | 1 |
| 1 | 3.1 | 86 | 5 | | | | | 0.2 | 4 | | | 5 |
| 1 | 1.1 | 81 | | | 9 | | 0.5 | 0.5 | | | 9 | |
| 1 | 2.5 | 60 | 4 | 15 | 3 | 3 | | | 6 | 10 | 5 | 4 |
| 1 | 5 | 65 | | 20 | | | | | 10 | | | |
| 1 | 2.4 | 75 | 5 | 4 | | 5 | | | | 6 | | 5 |
| 1 | 4.1 | 80 | 3 | 5 | 2 | 10 | | 0.3 | | | | |
| 1 | 3.2 | 65 | | 5 | 4 | 6 | | | 5 | 4 | 6 | 5 |
| 1 | 5.1 | 96 | | | | | | | | 4 | | |
| 1 | 10.8 | 90 | 5 | | | | | | 5 | | | |
| 1 | 10.0 | 80 | 2 | 6 | 2 | 5 | | | 1 | | 4 | |
| 1 | 1.8 | 80 | | 5 | | | | | | | 15 | |
| 1 | 2.6 | 84 | | | 11 | | | | | | 5 | |
| 1 | 3.3 | 80 | 2 | | | 10 | | | | 2 | | 6 |
| 1 | 12.0 | 90 | | | | 7 | 0.3 | | 3 | | | |
| 1 | 5.4 | 69 | 2 | 20 | 2 | 1 | | | | | 3 | 3 |
| 1 | 6.0 | 91 | | | 4 | | | | | | 5 | |

1. A process for printing an image on a substrate comprising applying to the substrate by means of an ink jet printer an ink comprising a liquid medium and a compound of Formula (1) or salt thereof: 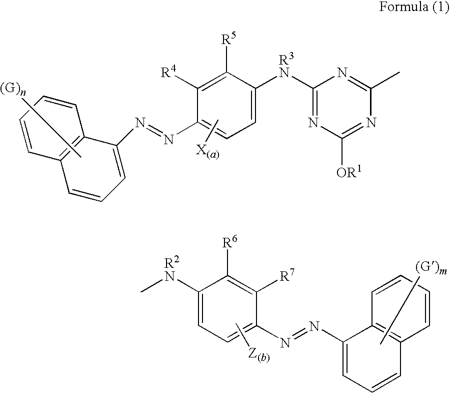
wherein:
R⁴, R⁵, R⁶ and R⁷ are each independently H or an optionally substituted substituent or R⁴ and R⁵ and/or R⁶ and R⁷ together with the carbon atoms to which they are attached form an optionally substituted aryl or heterocyclic ring;
X and Z are each independently H or an optionally substituted substituent;
R¹ is H or C₁₋₄-alkyl;
R² and R³ are each independently H, C₁₋₄-alkyl, —CONR⁸R⁹, —SO₂NR⁸R⁹ or aryl groups wherein R⁸ and R⁹ are each independently H, optionally substituted C₁₋₈-alkyl, an optionally substituted aryl or heterocyclic ring, or R⁸ and R⁹ together with the nitrogen atom to which they are attached form an optionally substituted 5 or 6 membered ring;
G and G′ are each independently a sulfonic acid group, carboxylic acid group or a phosphonic acid group;
n and m are each independently 0, 1, 2, 3, 4 or 5; and
a and b are each independently 0, 1 or 2.

2. A process according to claim 1 wherein X and Z are each independently H, optionally substituted alkyl, optionally substituted alkoxy, optionally substituted aryl, optionally substituted heterocyclic, —NR⁸R⁹, —NHCOR⁸, —NHCONR⁸R⁹, —C(O)R⁸, —C(O)OR⁸, —C(O)NR⁸R⁹, —PO₃H₂, —SR⁸, —SO₂R⁸, —SO₂NR⁸R⁹, —SOR⁸, —SO₃H, —CF₃, —CN, —NO₂, hydroxy or halogen.

3. A process according to claim 1 wherein R⁴, R⁵, R⁶ and R⁷ are each independently H, optionally substituted alkyl, optionally substituted alkoxy, optionally substituted aryl, optionally substituted heterocyclic, —NR⁸R⁹, —NHCOR⁸, —NHCONR⁸R⁹, —C(O)R⁸, —C(O)OR⁸, —C(O)NR⁸R⁹, —PO₃H₂, —SR⁸, —SO₂R⁸, —SO₂NR⁸R⁹, —SOR⁸, —SO₃H, —CF₃, —CN, —NO₂, hydroxy or halogen or R⁴ and R⁵ and/or R⁶ and R⁷ together with the carbon atoms to which they are attached form an optionally substituted 5 or 6 membered aryl or heterocyclic ring.

4. A compound process according to claim 1 wherein R⁴, R⁵, R⁶, R⁷, X and Z are each independently H, optionally substituted C₁₋₄-alkyl, optionally substituted C₁₋₄-alkoxy, —SO₂NR⁸R⁹ or —NHCONR⁸R⁹.

5. A process according to claim 1 wherein R¹ is H.

6. A process according to claim 1 wherein R¹, R² and R³ are all H.

7. A process according to claim 1 wherein the compound of Formula (1) or salt thereof has from 2 to 6 sulfonic acid groups.

8. A process according to claim 1 wherein G and G′ are each a sulfonic acid group.

9. A process according to claim 1 wherein n and m are each independently 1, 2 or 3.

10. A process according to claim 1 wherein a and b are each independently 0 or 1.

11. A process according to claim 1 wherein one or more of the groups represented by R⁴, R⁵, R⁶ and R⁷ is H.

12. A process according to claim 1 wherein the compound of Formula (1) or salt thereof is a compound of Formula (2) or salt thereof:

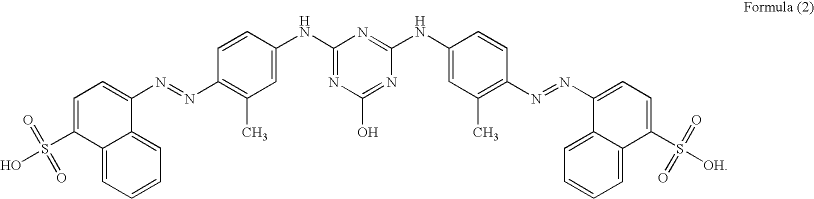

13. (canceled)

14. An ink comprising:
(a) a compound of Formula (1) or salts thereof: 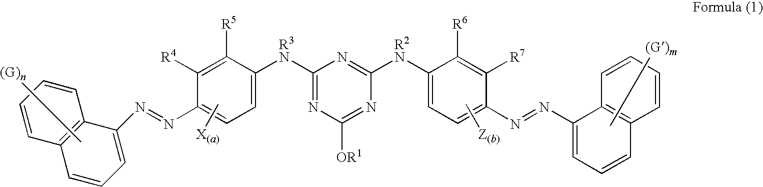
wherein:
R⁴, R⁵, R⁶ and R⁷ are each independently H or an optionally substituted substituent or R⁴ and R⁵ and/or R⁶ and R⁷ together with the carbon atoms to which they are attached form an optionally substituted aryl or heterocyclic ring;
X and Z are each independently H or an optionally substituted substituent;
R¹ is H or C₁₋₄-alkyl;
R² and R³ are each independently H, C₁₋₄alkyl, —CONR⁸R⁹, —SO₂NR⁸R⁹ or aryl groups wherein R⁸ and R⁹ are each independently H, optionally substituted C₁₋₈-alkyl, an optionally substituted aryl or heterocyclic ring, or R⁸ and R⁹ together with the nitrogen atom to which they are attached form an optionally substituted 5 or 6 membered ring;
G and G′ are each independently a sulfonic acid group, carboxylic acid group or a phosphonic acid group;
n and m are each independently 0, 1, 2, 3, 4 or 5;
a and b are each independently 0.1 or 2; and
(b) a liquid medium;
wherein the ink has a concentration of halide ions of less than 500 ppm by weight relative to the total weight of the ink.

15. (canceled)

16. A substrate printed with an ink according to claim 14.

17. An ink jet printer cartridge, comprising a chamber and an ink, wherein the ink is present in the chamber and the ink is according to claim 14.

18. An ink jet printer containing an ink jet printer cartridge according to claim 17.

19. (canceled)

20. An ink according to claim 14 wherein the liquid medium comprises a mixture of water and a water-miscible organic solvent selected from the group consisting of cyclic amides, diols, mono-C₁₋₄-alkyl and C₁₋₄-alkyl ethers of diols.

21. A compound of Formula (7) or salt thereof [chemical structure]
